(19) United States
(12) Patent Application Publication
(10) Pub. No.: US 2011/0300359 A1
(43) Pub. Date: Dec. 8, 2011

(54) PAINTER'S CANVAS INCLUDING AN AGENT CAPABLE OF TRAPPING FORMALDEHYDE AND MANUFACTURING PROCESS

(75) Inventors: Benjamin Blanchard, Taverny (FR); Katarzyna Chuda, Paris (FR); Boris Jaffrennou, Paris (FR)

(73) Assignee: SAINT-GOBAIN ADFORS, Chambery (FR)

(21) Appl. No.: 13/141,018

(22) PCT Filed: Dec. 18, 2009
(86) PCT No.: PCT/FR2009/052626

§ 371 Date: Aug. 25, 2011

(30) Foreign Application Priority Data
Dec. 19, 2008 (FR) 0858856

(51) Int. Cl. B32B 17/02; B05D 3/02; B32B 5/10; B32B 27/00

(52) U.S. Cl. 428/219; 427/372.2; 442/121

(57) ABSTRACT

The present invention relates to a painter's canvas based on glass fibers intended to be applied to an interior surface of a building, which includes an agent capable of trapping formaldehyde chosen from compounds comprising active methylene(s), hydrazides, tannins, amides, amino acids, peptides and proteins.

Another subject matter of the present invention is the process for producing said painter's canvas.

The invention relates to a painter's canvas based on glass fibers which is intended to be applied to an interior surface of a building and which includes an agent capable of trapping formaldehyde.

The invention also relates to the method for obtaining said painter's canvas.

Highly varied materials are used in the interior construction and interior fitting out of dwellings and offices. Some of these materials, such as sound and/or thermal insulators, wooden panels, furniture and decorative parts, use adhesives, paints and varnishes employing formaldehyde.

The proportion of free formaldehyde in these materials is already very low. Nevertheless, regulations regarding protection against undesired emissions of products which may exhibit a risk to the health of the individual are becoming stricter and require a further reduction in the amount of free formaldehyde or formaldehyde capable of being emitted by materials over time.

Means for reducing the amount of formaldehyde inside buildings are known.

The proposal has been made to include particles of photocatalytic titanium oxide in a paint or a material made of plaster (US-A-2005/0226761), a paper or a textile, plastic or wooden material (EP-A-1 437 397).

It is also known to use a hydrazide in a construction material based on plaster or on cement (US-A-2004/0101695 and JP-A-2004115340).

The proposal has also been made to add calcined oyster shell powder to a paint or paper, in particular a wallpaper (JP-A-2005230729).

The aim of the present invention is to reduce the amount of formaldehyde present inside buildings.

To achieve this aim, the present invention provides a painter's canvas based on glass fibers which comprises an agent capable of trapping formaldehyde.

Another subject matter of the invention is the process for the manufacture of the painter's canvas.

“Compound capable of reacting with formaldehyde” is understood to mean an organic compound which bonds to formaldehyde via a covalent bond.

Preferably, the compound capable of reacting with formaldehyde is chosen from:

1—compounds comprising active methylene(s), preferably corresponding to the following formulae:

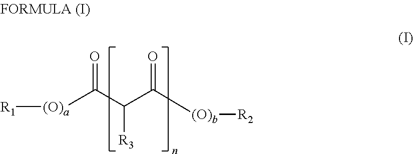

in which:
R₁ and R₂, which are identical or different, represent a hydrogen atom, a C₁-C₂₀, preferably C₁-C₆, alkyl radical, an amino radical or a radical of formula

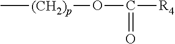

in which R₄ represents a

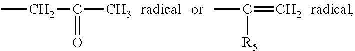

where R₅═H or —CH₃, and p is an integer varying from 1 to 6,
R₃ represents a hydrogen atom, a C₁-C₁₀ alkyl radical, a phenyl radical or a halogen atom,
a is equal to 0 or 1,
b is equal to 0 or 1,
n is equal to 1 or 2.

The preferred compounds of formula (I) are:
2,4-pentanedione:
   R₁=—CH₃; R₂=—CH₃; R₃=H; a=0; b=0, n=1
2,4-hexanedione:
   R₁=—CH₂—CH₃; R₂=—CH₃; R₃=H; a=0; b=0, n=1
3,5-heptanedione:
   R₁=—CH₂—CH₃; R₂=—CH₂—CH₃; R₃=H; a=0; b=0, n=1
2,4-octanedione:
   R₁=—CH₃; R₂=—(CH₂)₃—CH₃; R₃=H; a=0; b=0, n=1
acetoacetamide:
   R₁=—CH₃; R₂=—NH₂; R₃=H; a=0; b=0, n=1
acetoacetic acid:
   R₁=—CH₃; R₂=H; R₃=H; a=0; b=1, n=1
methyl acetoacetate:
   R₁=—CH₃; R₂=—CH₃; R₃=H; a=0; b=1, n=1
ethyl acetoacetate:
   R₁=—CH₃; R₂=—CH₂—CH₃; R₃=H; a=0; b=1, n=1
n-propyl acetoacetate:
   R₁=—CH₃; R₂=—(CH₂)₂—CH₃; R₃=H; a=0; b=1, n=1
isopropyl acetoacetate:
   R₁=—CH₃; R₂=—CH(CH₃)₂; R₃=H; a=0; b=1, n=1
isobutyl acetoacetate:
   R₁=—CH₃; R₂=—CH₂—CH(CH₃)₂; R₃=H; a=0; b=1, n=1
t-butyl acetoacetate:
   R₁=—CH₃; R₂=—C(CH₃)₃; R₃=H; a=0; b=1, n=1
n-hexyl acetoacetate:
   R₁=—CH₃; R₂=—(CH₂)₅—CH₃; R₃=H; a=0; b=1, n=1
malonamide:
   R₁=—NH₂; R₂=—NH₂; R₃=H; a=0; b=0, n=1
malonic acid:
   R₁=H; R₂=H; R₃=H; a=1; b=1, n=1
dimethyl malonate:
   R₁=—CH₃; R₂=—CH₃; R₃=H; a=1; b=1, n=1
diethyl malonate:
   R₁=—CH₂—CH₃; R₂=—CH₂—CH₃; R₃=H; a=1; b=1, n=1
di(n-propyl) malonate:
   R₁=—(CH₂)₂—CH₃; R₂=—(CH₂)₂—CH₃; R₃=H; a=1; b=1, n=1
diisopropyl malonate:
   R₁=—CH(CH₃)₂; R₂=—CH(CH₃)₂; R₃=H; a=1; b=1, n=1
di(n-butyl) malonate:
   R₁=—(CH₂)₃—CH₃; R₂=—(CH₂)₃—CH₃; R₃=H; a=1; b=1, n=1
acetonedicarboxylic acid:
   R₁=H; R₂=H; R₃=H; a=1; b=1, n=2
dimethyl acetonedicarboxylate:
   R₁=—CH₃; R₂=—CH₃; R₃=H; a=1; b=1, n=2
1,4-butanediol diacetate:
   R₁=—CH₃; R₂=—(CH₂)₄—O—CO—CH₂—CO—CH₃; R₃=H; a=0; b=1, n=1
1,6-hexanediol diacetate:
   R₁=—CH₃; R₂=—(CH₂)₆O—CO—CH₂—CO—CH₃; R₃=H; a=0; b=1, n=1
methacryloyloxyethyl acetoacetate:
   R₁=—CH₃; R₂=—(CH₂)₂—O—CO—C(CH₃)═CH₂; R₃=H; a=0; b=1, n=1

FORMULA (II)

R₆—CHR₇—C≡N (II)

in which:
R₆ represents a cyano radical or a

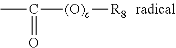

in which:
R₈ represents a hydrogen atom, a C₁-C₂₀, preferably C₁-C₆, alkyl radical or an amino radical
c is equal to 0 or 1
R₇ represents a hydrogen atom, a C₁-C₁₀ alkyl radical, a phenyl radical or a halogen atom.

The preferred compounds of formula (II) are:
methyl 2-cyanoacetate:
   R₆=—CO—O—CH₃; R₇=H
ethyl 2-cyanoacetate:
   R₆=—CO—O—CH₂—CH₃; R₇=H
n-propyl 2-cyanoacetate:
   R₆=—CO—O— (CH₂)₂—CH₃; R₇=H
isopropyl 2-cyanoacetate:
   R₆=—CO—O—CH(CH₃)₂; R₇=H
n-butyl 2-cyanoacetate:
   R₆=—CO—O—(CH₂)₃CH₃; R₇=H
isobutyl 2-cyanoacetate:
   R₆=—CO—O—CH₂—CH(CH₃)₂; R₇=H
tert-butyl 2-cyanoacetate:
   R₆=—CO—O—C(CH₃)₃; R₇=H
2-cyanoacetamide:
   R₆=—CO—NH₂; R₅=H
propane dinitrile:
   R₆=—C≡N; R₅=H

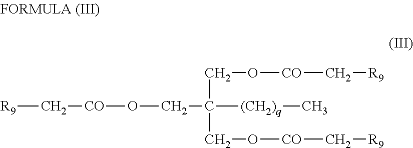

in which:
R₉ represents a —C≡N or —CO—CH₃ radical
q is an integer varying from 1 to 4.

The preferred compounds of formula (III) are:
trimethylolpropane triacetoacetate:
   R₉=—CO—CH₃; q=1
trimethylolpropane tricyanoacetate:
   R₉=—C≡N; q=1

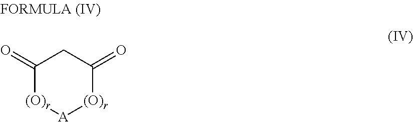

in which:
A represents a —(CH₂)₃— or —C(CH₃)₂— radical
r is equal to 0 or 1.

The preferred compounds of formula (IV) are:
1,3-cyclohexanedione:
A=—(CH₂)₃; r=0
Meldrum's acid:
A=—C(CH₃)₂—; r=1.

2-hydrazides, for example:

a) monohydrazides of formula R₁CONHNH₂ in which R₁ represents an alkyl radical, for example a methyl, ethyl, n-propyl, isopropyl, n-butyl, sec-butyl, or tert-butyl radical, or an aryl radical, for example a phenyl, biphenyl or naphthyl radical, it being understood that a hydrogen atom of said alkyl or aryl radicals can be replaced by a hydroxyl group or a halogen atom and said aryl radical can be substituted by an alkyl radical, for example a methyl, ethyl or n-propyl radical,
b) dihydrazides of formula H₂NHN—X—NHNH₂ in which X represents a —CO— or —CO—Y—CO radical, and Y is an alkylene radical, for example a methylene, ethylene or trimethylene radical, or an arylene radical, for example a phenylene, biphenylene or naphthylene radical, it being understood that a hydrogen atom of said alkylene or arylene radicals can be replaced by a hydroxyl group or a halogen atom and said aryl radical can be substituted by an alkyl radical, for example a methyl, ethyl or n-propyl radical. Mention may be made, by way of examples, of oxalic acid dihydrazide, malonic acid dihydrazide, succinic acid dihydrazide, adipic acid dihydrazide, sebacic acid dihydrazide, maleic acid dihydrazide, fumaric acid dihydrazide, diglycolic acid dihydrazide, tartaric acid dihydrazide, malic acid dihydrazide, isophthalic acid dihydrazide, terephthalic acid dihydrazide and carbohydrazide,
c) polyhydrazides, such as trihydrazides, in particular citric acid trihydrazide, pyromellitic acid trihydrazide, 1,2,4-benzenetrihydrazide, nitrilotriacetic acid trihydrazide and cyclohexanetricarboxylic acid trihydrazide, tetrahydrazides, in particular ethylenediaminetetraacetic acid tetrahydrazide or 1,4,5,8-naphthoic acid tetrahydrazide, and polyhydrazides formed from a hydrazide monomer comprising a polymerizable group, for example a poly(acrylic acid hydrazide) or a poly(methacrylic acid hydrazide).
3—tannins, in particular condensed tannins, such as mimosa, quebracho, pine, pecan nut, hemlock wood and sumac tannins.
4—amides, for example urea, 1,3-dimethylurea, ethyleneurea and its derivatives, such as N-hydroxyethyleneurea, N-aminoethylethyleneurea, N-(3-allyloxy-2-hydroxypropyl)aminoethylethyleneurea, N-acryloxyethylethyleneurea, N-methacryloxyethylethyleneurea, N-acrylaminoethylethyleneurea, N-methacrylaminoethylethyleneurea, N-methacryloyloxyacetoxyethyleneurea, N-methacryloyloxyacetaminoethylethyleneurea and N-di(3-allyloxy-2-hydroxypropyl)aminoethylethyleneurea, diurea, biuret, triuret, acrylamide, methacrylamide, polyacrylamides and polymethacrylamides,
5-amino acids, for example glycine, peptides and proteins of animal or plant origin.

The amount of agent capable of trapping formaldehyde to be used can vary to a large extent, for example from 0.1 to 500 g/m² of the painter's canvas, preferably from 0.5 to 100 g/m² and advantageously from 1 to 50 g/m².

If appropriate, the agent capable of trapping formaldehyde can additionally comprise at least one porous material which adsorbs formaldehyde.

This porous material is provided in the form of particles having a size which varies from 10 nm to 100 μm, preferably from 500 nm to 50 μm and advantageously from 1 to 10 μm. Preferably, the particles exhibit a specific surface which varies from 1 to 5000 m²/g, advantageously from 5 to 2000 m²/g, and a mean pore diameter varying from 1 to 50 nm, preferably from 1 to 20 nm.

The porous material can be pyrogenic or non-pyrogenic and microporous or mesoporous silica, a carbon black, a zeolite or a porous polymer.

The painter's canvas in accordance with the invention is based on glass fibers and can optionally comprise fibers composed of a thermoplastic organic material, such as polyethylene and polypropylene.

Preferably, the painter's canvas is a fabric obtained from glass yarns composed of a multitude of glass filaments (or base yarn) or derived from these yarns, in particular the assemblies of these base yarns in the form of rovings, or from mixed yarns comprising at least one glass yarn composed of a multitude of glass filaments and at least one yarn composed of a multitude of filaments of the abovementioned thermoplastic organic material, or from “comingled” yarns composed of glass filaments and of filaments of the above-mentioned organic material which are intimately mixed.

The abovementioned yarns can be twist-free yarns or twisted yarns.

The glass participating in the composition of the yarns can be of any type, for example E, C, R or AR (alkali-resistant). The glass E is preferred.

The diameter of the glass filaments constituting the yarns can vary to a large extent, for example from 5 to 30 μm. In the same way, wide variations can occur in the linear density of the yarn, which can range from 34 to 1500 tex.

Advantageously, the painter's canvas comprises, in the warp, a twisted glass yarn (textile yarn) and, in the weft, a twist-free glass yarn, having been subjected to a treatment targeted at separating the glass filaments so as to confer volume thereon (or “bulked” yarn). The linear density of the warp and weft yarns preferably varies from 50 to 500 tex.

Preferably, the painter's canvas exhibits a weight per unit area which varies from 30 to 1000 g/m².

Conventionally, the painter's canvas is coated with a finishing composition which maintains the yarns, hides the pores and confers on it the stiffness which is suitable for the positioning on the final support to be able to be suitably carried out. Preferably, the coating is carried out on both faces of the painter's canvas.

The finishing composition is generally provided in the form of an aqueous solution comprising, as percentage by weight:
5 to 100% of a structuring compound composed of a starchy compound which is soluble under cold conditions, at a temperature of the order of 25° C., such as a starch,
0 to 90% of a polymer having a hydrophobic nature, for example a homo- or a copolymer of vinyl acetate, of (meth)acrylic acid, in particular a styrene/(meth)acrylic acid copolymer,
0 to 15% of a white and concealing filler, for example titanium oxide,
0 to 40% of a flame retardant, for example zirconium salts,
0 to 30% of a foaming agent, for example an amine oxide,
0 to 20% of a foam-stabilizing agent, for example ammonium stearate,
0 to 20% of a water repellant, for example a paraffin or antimony trioxide,
0 to 10% of a biocidal and/or antifungal agent.

The painter's canvas can comprise an additional layer of an adhesive which can react with water on its face on the wrong side (face which, in the final arrangement, is adhesively bonded to the support). Such a layer allows the operator, by simply applying water to the coated face, to reactivate the adhesive-treated face and to position the canvas directly on the support.

The process for the manufacture of the painter's canvas constitutes another subject matter of the present invention.

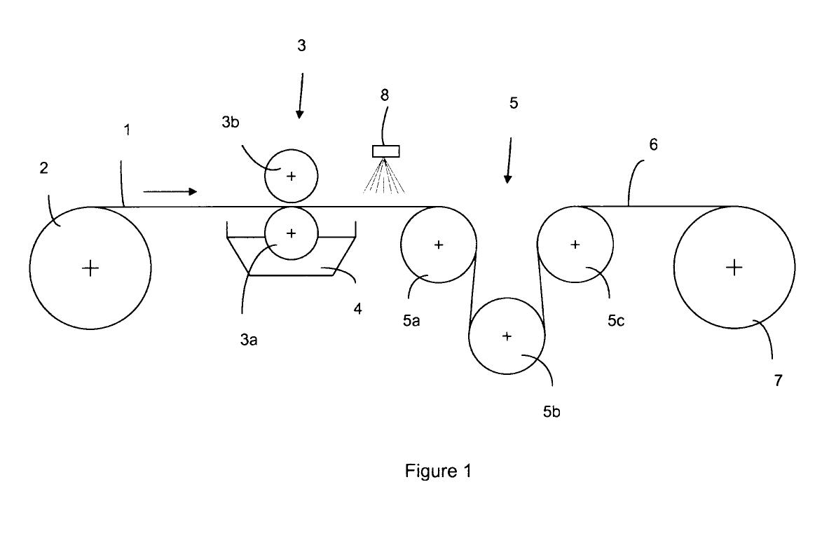

FIG. 1 is a diagrammatic view of a conventional plant which makes it possible to apply the finishing composition to a painter's canvas.

The painter's canvas (1), unwound from the reel (2) in the direction indicated by the arrow, passes into a padding machine (3) comprising a roller (3a), which dips into a tank (4) containing the finishing composition, and a roller (3b). On passing over the roller 3a, the painter's canvas (1) is coated with the finishing composition and the amount deposited is adjusted by the distance between the rollers 3a and 3b.

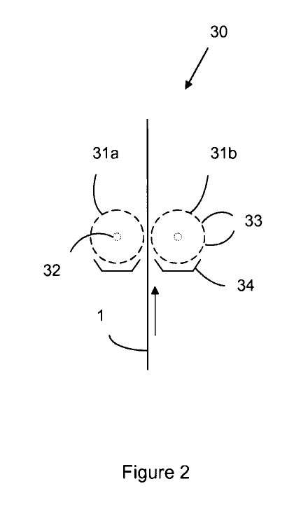

According to an alternative form of the process, the padding machine 3 is replaced by the device 30 of FIG. 2, which comprises two rollers 31a and 31b each comprising a central pipe 32 for introducing the finishing composition under pressure. The peripheral region of the rollers 31a and 31b is provided with perforations 33 through which the finishing composition passes, which composition is deposited on the painter's canvas. A device 34 placed under the rollers 31a and 31b makes it possible to recover the excess finishing composition.

This alternative embodiment makes it possible to apply the finishing composition to both faces of the painter's canvas (1). It exhibits the advantage of not “squashing” the weaving pattern of the painter's canvas: said pattern thus retains its original relief, which can be shown off to advantage subsequently by the application of the paint.

The coated painter's canvas subsequently passes into a drying device (5) comprising three heating rollers (5a, 5b, 5c), on contact with which the water is removed. The number of rollers present in the drying device varies from 1 to 20 and preferably does not exceed 14.

Advantageously, the temperature in the drying device decreases, namely the first roller is heated to a higher temperature than that of the final roller. The maximum temperature to be applied at the first roller depends on the nature of the yarns of which the painter's canvas is composed. By way of example, the temperature of the first roller is equal to 240° C. and that of the final roller is equal to 110° C. when the yarns are made of glass. The maximum temperature of the first roller is lower if comingled yarns comprising filaments of thermoplastic organic material are concerned. The maximum temperature, however, must not exceed the melting point of the thermoplastic organic material having the lowest melting point.

Other drying devices can be used, for example devices which deliver hot air or which operate by infrared radiation.

If appropriate, one or more other unheated rollers can be placed after the drying device 5 (not represented).

The role of these rollers is in particular to guide the canvas and/or to adjust the speed of the line in order to make it possible to replace the reel 2.

The finished painter's canvas (6) is subsequently collected in the form of a winding (7).

In accordance with the invention, a stage of treatment with an agent capable of trapping formaldehyde is added to this conventional plant.

According to a first embodiment, the agent capable of trapping formaldehyde is introduced into the finishing composition. This embodiment is preferred as it does not require any additional device for the application of the agent capable of trapping formaldehyde, which is advantageous from an economic viewpoint.

According to a second embodiment, the agent capable of trapping formaldehyde is applied after the padding machine (3) or the device (30) and before the painter's canvas passes onto the drying device (5).

Said agent can be applied by any known means, preferably using the device which operates by spraying (8) described in FIG. 1.

For example, this device can be composed of a plurality of spray nozzles fed with an aqueous solution of the agent capable of trapping formaldehyde which generate divergent streams which interpenetrate shortly before arriving in contact with the upper face (or face on the right side) of the painter's canvas.

If appropriate, the agent capable of trapping formaldehyde can additionally be applied to the lower face (or face on the wrong side), for example using a conventional applicator roll.

The agent capable of trapping formaldehyde can also be applied by uptake on the finished painter's canvas, preferably on the face on the right side. However, it is more expensive to proceed in this way as an additional stage and specific means for applying the agent capable of trapping formaldehyde in the form of an aqueous solution and for removing the water are required.

The examples which follow make it possible to illustrate the invention without, however, limiting it.

### EXAMPLES 1 AND 2

A finishing composition is prepared which comprises the following constituents, as percentages by weight:

| | |
|---|---|
| Starch which is soluble at 25° C. | 5.5 |
| Acrylic binder (Acronal ® S559, BASF) | 9.2 |
| Titanium oxide | 0.2 |
| Paraffin | 0.3 |
| Zirconium salts | 0.4 |
| Agent capable of trapping formaldehyde | 5.4 |
| Water | 79.0 |

The finishing composition is obtained by introducing the water and the various constituents into a container, with stirring, the agent capable of trapping formaldehyde being introduced last. The agent capable of trapping formaldehyde is acetoacetamide (example 1) and adipic acid dihydrazide (example 2).

The finishing composition is used to coat a painter's canvas provided in the form of a glass cloth with a weight per unit area of 120 g/m² comprising, in the weft, a textured glass yarn having a linear density of the order of 330 tex with a weft density of 1.9 yarn per cm and, in the warp, a glass yarn having a linear density of the order of 140 tex and a warp density of 3 yarns per cm.

The finishing composition is applied in the plant of FIG. 1.

The padding machine (3) is adjusted so as to deposit of the order of 310 g of finishing composition per m² of painter's canvas.

The painter's canvas collected includes 65 g of finish (dry matter) per m² of painter's canvas, the amount of agent capable of trapping formaldehyde being equal to 17 g.

This canvas is subjected to the tests for absorption and desorption of formaldehyde under the following conditions.

A sample of the painter's canvas is placed in a device in accordance with ISO standard 16000-9, modified in that, in the test chamber, the relative humidity level is equal to 45%.

a) in a first step, the chamber is fed for 7 days with a continuous stream of air comprising of the order of 50 μg/m³ of formaldehyde. The amount of formaldehyde in the air entering and departing from the chamber is measured and the percentage of absorption of the formaldehyde by the painter's canvas is calculated.
b) in a second step, the chamber is fed for one day with air not comprising formaldehyde and the amount of formaldehyde present in the air at the outlet of the chamber is measured.

The formaldehyde is measured by liquid chromatography (HPLC) under the conditions of ISO standard 16000-3.

The percentage of formaldehyde absorbed by the painter's canvas and the amount of formaldehyde in the air at the outlet of the chamber for a painter's canvas coated with the finishing composition including the agent capable of trapping formaldehyde are shown in table 1 (examples 1 and 2) in comparison with the canvas coated with the finishing composition not comprising agent capable of trapping formaldehyde (Reference).

TABLE 1

| | Ex. 1 | Ex. 2 | Ref. |
|---|---|---|---|
| a) formaldehyde absorbed | | | |
| (%) | | | |
| 1 day | 66 | 39 | 5 |
| 2 days | 68 | 47 | 7 |
| 3 days | 61 | 30 | 0 |
| 7 days | 66 | 33 | 5 |
| b) formaldehyde given off | 6 | 6 | 18 |
| (μg/m³) | | | |

It is found that the amount of formaldehyde absorbed is greater for examples 1 and 2 than for the Reference: the absorption of formaldehyde is respectively 13 times (example 1) and 7.8 times (example 2) greater on 1 day and remains relatively constant throughout the duration of the test.

The formaldehyde given off in examples 1 and 2 is much lower than for the Reference. It is specified that the value of 6 μg/m³ corresponds to the amount of formaldehyde given off measured under the conditions where the test chamber does not comprise any sample of painter's canvas.

### EXAMPLES 3 TO 6

A finishing composition is prepared which comprises the following constituents, as percentages by weight:

| | |
|---|---|
| Starch which is soluble at 25° C. | 3.9 |
| Acrylic binder (Acronal ® S559, BASF) | 11.8 |
| Titanium oxide | 0.1 |
| Paraffin | 0.5 |
| Zirconium salts | 1.50 |
| Agent capable of trapping formaldehyde | 3.8 |
| Water | 78.4 |

The finishing composition is obtained by introducing the water and the various constituents into a container, with stirring, the agent capable of trapping formaldehyde being introduced last.

The agent capable of trapping formaldehyde is acetoacetamide (example 3), adipic acid dihydrazide (example 4), ethyleneurea (example 5) and an acacia tannin (example 6).

The finishing composition is used to coat a painter's canvas provided in the form of a glass cloth with a weight per unit area of 80 g/m² comprising, in the weft, a textured glass yarn having a linear density of the order of 330 tex with a weft density of 1.9 yarn per cm and, in the warp, a glass yarn having a linear density of the order of 140 tex and a warp density of 3 yarns per cm.

The finishing composition is applied in the plant of FIG. 1.

The padding machine (3) is adjusted so as to deposit of the order of 470 g of finishing composition per m² of painter's canvas.

The painter's canvas collected includes 65 g of finish (dry matter) per m² of painter's canvas, the amount of agent capable of trapping formaldehyde being equal to 18 g.

This canvas is subjected to the tests for absorption and desorption of formaldehyde under the following conditions.

A sample of the painter's canvas is placed in a device in accordance with ISO standard 16000-9, modified in that, in the test chamber, the relative humidity level is equal to 50%.

a) in a first step, the chamber is fed for three days with a continuous stream of air comprising of the order of 50 μg/m³ of formaldehyde. The amount of formaldehyde in the air entering and departing from the chamber is measured and the percentage of absorption of the formaldehyde by the painter's canvas is calculated.
b) in a second step, the chamber is fed with air not comprising formaldehyde and the amount of formaldehyde present in the air at the outlet of the chamber is measured after 2, 4 and 8 days.

The formaldehyde is measured by liquid chromatography (HPLC) under the conditions of ISO standard 16000-3 using a detector which makes it possible to achieve a detection threshold of 3 μg/m³.

The percentage of formaldehyde absorbed by the painter's canvas and the amount of formaldehyde in the air at the outlet of the chamber for a painter's canvas coated with the finishing composition including the agent capable of trapping formaldehyde are shown in table 2 in comparison with a test chamber not comprising any painter's canvas (Reference).

The results of the adsorption and desorption tests are given in table 2.

TABLE 2

| | Ex. 3 | Ex. 4 | Ex. 5 | Ex. 6 | Ref. |
|---|---|---|---|---|---|
| a) formaldehyde | | | | | |
| absorbed (%) | | | | | |
| 1 day | 67 | 26 | 5 | 12 | — |
| 2 days | 76 | 48 | 26 | 20 | — |
| 3 days | 67 | 35 | 22 | 12 | — |
| b) formaldehyde | | | | | |
| given off (μg/m³) | | | | | |
| 2 days | 3 | 3.7 | 3 | 3 | 3 |
| 4 days | 3 | 3 | 3 | 3 | 3 |
| 8 days | 3 | 3 | 3 | 3 | 3 |

1. A painter's canvas, comprising:
at least one glass fiber comprising a finish suitable to form a covering on an interior surface of a building; and
an agent capable of trapping formaldehyde.

2. The canvas of claim 1, the agent is at least one selected from the group consisting of a compound comprising at least one active methylene, a hydrazide, a tannin, an amide, an amino acid, a peptide, and a protein.

3. The canvas of claim 2, wherein the compound comprising at least one active methylene is present and has formula (I), (II), (III), or (IV): 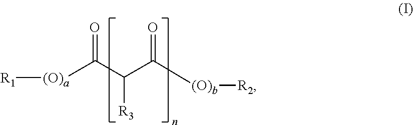
wherein
R₁ and R₂, which are identical or different, represent a hydrogen atom, a C₁-C₂₀, preferably C₁-C₆, alkyl radical, an amino radical or a radical of formula 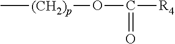
wherein R₄ represents a 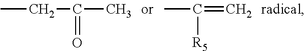
wherein R₅ is H or —CH₃, and p is an integer varying from 1 to 6,
R₃ represents a hydrogen atom, a C₁-C₁₀ alkyl radical, a phenyl radical or a halogen atom,
a is equal to 0 or 1,
b is equal to 0 or 1, and
n is equal to 1 or 2;
R₆—CHR₇—C≡N (II)
wherein
R₆ represents a cyano radical or a 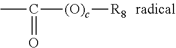
wherein
R₈ represents a hydrogen atom, a C₁-C₂₀alkyl radical or an amino radical,
c is equal to 0 or 1, and
R₇ represents a hydrogen atom, a C₁-C₁₀ alkyl radical, a phenyl radical or a halogen atom; 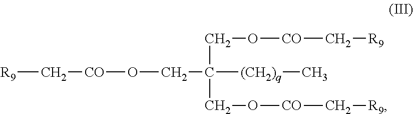
wherein
R₉ represents a —C≡N or —CO—CH₃ radical
q is an integer varying from 1 to 4; 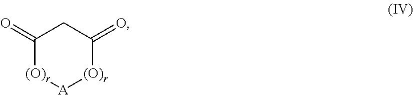
wherein
A represents a —(CH₂)₃— or —C(CH₃)₂— radical
r is equal to 0 or 1.

4. The canvas of claim 3, wherein the compound of formula (I) is present and is at least one selected from the group consisting of 2,4-pentanedione, 2,4-hexanedione, 3,5-heptanedione, 2,4-octanedione, acetoacetamide, acetoacetic acid, methyl acetoacetate, ethyl acetoacetate, n-propyl acetoacetate, isopropyl acetoacetate, isobutyl acetoacetate, t-butyl acetoacetate, n-hexyl acetoacetate, malonamide, malonic acid, dimethyl malonate, diethyl malonate, di(n-propyl) malonate, diisopropyl malonate, di(n-butyl) malonate, acetonedicarboxylic acid and dimethyl acetonedicarboxylate.

5. The canvas of claim 3, wherein the compound of formula (II) is present and is at least one selected from the group consisting of methyl 2-cyanoacetate, ethyl 2-cyanoacetate, n-propyl 2-cyanoacetate, isopropyl 2-cyanoacetate, n-butyl 2-cyanoacetate, isobutyl 2-cyanoacetate, tert-butyl 2-cyanoacetate, 2-cyanoacetamide and propane dinitrile.

6. The canvas of claim 3, wherein the compound of formula (III) is present and is at least one selected from the group consisting of trimethylolpropane triacetoacetate and trimethylolpropane tricyanoacetate.

7. The canvas of claim 3, wherein the compound of formula (IV) is present and is at least one selected from the group consisting of 1,3-cyclohexanedione and Meldrum's acid.

8. The canvas of claim 2, wherein the hydrazide is present and is at least one selected from the group consisting of:
a) a monohydrazide of formula R₁CONHNH₂ wherein R₁ represents an alkyl radical or an aryl radical, wherein, optionally, a hydrogen atom of the alkyl or aryl radicals is replaced by a hydroxyl group or a halogen atom and wherein, optionally, the aryl radical is substituted by an alkyl radical;
b) a dihydrazide of formula H₂NHN—X—NHNH₂ wherein X represents a —CO— or —CO—Y—CO radical, and Y is an alkylene radical or an arylene radical, wherein, optionally, a hydrogen atom of the alkylene or arylene radicals is replaced by a hydroxyl group or a halogen atom and wherein, optionally, the aryl radical is substituted by an alkyl radical; and
c) a polyhydrazide, formed from a hydrazide monomer comprising a polymerizable group.

9. The canvas of claim 8, wherein the hydrazide is present and is at least one selected from the group consisting of oxalic acid dihydrazide, malonic acid dihydrazide, succinic acid dihydrazide, adipic acid dihydrazide, sebacic acid dihydrazide, maleic acid dihydrazide, fumaric acid dihydrazide, diglycolic acid dihydrazide, tartaric acid dihydrazide, malic acid dihydrazide, isophthalic acid dihydrazide, terephthalic acid dihydrazide, carbohydrazide, citric acid trihydrazide, pyromellitic acid trihydrazide, 1,2,4-benzenetrihydrazide, nitrilotriacetic acid trihydrazide, cyclohexanetricarboxylic acid trihydrazide, ethylenediaminetetraacetic acid tetrahydrazide, 1,4,5,8-naphthoic acid tetrahydrazide, a poly(acrylic acid hydrazide), and a poly(methacrylic acid hydrazide).

10. The canvas of claim 2, wherein the tannin is present and is at least one selected from the group consisting of a mimosa, quebracho, pine, pecan nut, hemlock wood, and sumac tannin.

11. The canvas of claim 2, wherein the amide is present and is at least one selected from the group consisting of urea, 1,3-dimethylurea, ethyleneurea, an ethyleneurea derivative, diurea, biuret, triuret, acrylamide, methacrylamide, a polyacrylamide, and a polymethacrylamide.

12. The canvas of claim 1, wherein a content of the agent varies from 0.1 to 500 g/m².

13. The canvas of claim 1, further comprising at least one fiber comprising a thermoplastic organic material.

14. The canvas of claim 13, in the form of a fabric obtained from at least one glass yarn comprising a multitude of glass filaments, or base yarn, or derived from these yarns, or from mixed yarns comprising at least one glass yarn comprising a multitude of glass filaments and at least one yarn comprising a multitude of filaments comprising a thermoplastic organic material, or from “comingled” yarns comprising glass filaments and filaments comprising the thermoplastic organic material which are intimately mixed.

15. The canvas of claim 14, comprising, in a warp, a twisted glass yarn, and, in a weft, a bulked twist-free glass yarn,
wherein a linear density of the warp and weft yarns varies from 34 to 1500 tex.

16. The canvas of claim 1, having a weight per unit area varying from 30 to 1000 g/m².

17. A process for manufacturing the canvas of claim 1, comprising:
passing the canvas into a padding machine or device;
treating the canvas with an agent capable of trapping formaldehyde; and
drying the canvas.

18. The process of claim 17, wherein the treating comprises introducing the agent into a finishing composition.

19. The process of claim 17, wherein the treating comprises applying the agent after the padding machine or device and before the canvas passes onto a drying device.

20. The process of claim 19, wherein the applying is carried out by spraying an aqueous solution of agent.
